(19) United States
(12) Patent Application Publication
(10) Pub. No.: US 2008/0136064 A1
(43) Pub. Date: Jun. 12, 2008

(54) MOLDING APPARATUS AND A MOLDING METHOD

(75) Inventors: Douglas Jeffrey MacDonald, North York (CA); Craig Adam Reynolds, Bolton (CA)

Correspondence Address: HUSKY INJECTION MOLDING SYSTEMS, LTD;CO/AMC INTELLECTUAL PROPERTY GRP, 500 QUEEN ST. SOUTH, BOLTON, ON, L7E 5S5, omitted

(73) Assignee: HUSKY INJECTION MOLDING SYSTEMS LTD., Bolton (CA)

(21) Appl. No.: 11/609,710

(22) Filed: Dec. 12, 2006

(51) Int. Cl. B29C 59/16

(52) U.S. Cl. 264/478; 250/492.3; 264/485; 425/174.4

(57) ABSTRACT

Disclosed, amongst other things, is a molding apparatus and related method for producing aseptic preforms, and a molding apparatus and related method for a controlled crystallization of a molded article, amongst other things.

### TECHNICAL FIELD

The present invention generally relates to, but is not limited to, a molding apparatus and molding method, and more specifically the present invention relates to, but is not limited to, (i) a molding apparatus and related method for producing aseptic preforms, (ii) a molding apparatus and related method for a controlled crystallization of a molded article, amongst other things.

### BACKGROUND

U.S. Pat. No. 6,239,543 (Inventor: WAKALOPULOS, George, Published: 29 May, 2001) describes the construction of an electron beam generator use of an electron beam to irradiate and thereby sterilize and depyrogenate the internal walls of an empty vial.

U.S. Pat. No. 6,231,939 (Inventor: SHAW, David, et al., Published: 15 May, 2001) describes a process including the steps of injection or blow molding a container, deposition of an acrylate layer, and irradiation of the acrylate layer with ultraviolet or an electron beam to cause polymerization of the acrylate to form a cross-linked layer.

U.S. Pat. No. 5,725,715 (Inventor: MAKUUCHI, Kelzo, et al., Published: 10 Mar. 1998) describes a process for forming a squeezable tubular container including the steps of molding the tubular molded article (e.g. injection or extrusion molding methods) containing a polyolefin composition, and irradiating the tubular container to cause a cross-linking thereof.

United States patent application 2005/0012051 (Inventor: HUEBNER, Gerhard, Published: 20 Jan. 2005) describes a device for irradiation of products (e.g. pipes) to cause a polymerization/crosslinking thereof.

### SUMMARY OF THE INVENTION

In accordance with a first aspect of the present invention an electron beam generator is provided for use in a molding system. The electron beam generator including an electron beam tube having an emitter for emitting an electron beam, and a drive configured to controllably position the electron beam tube to position the electron beam on a portion of a molded article.

In accordance with a second aspect of the present invention a molding system is provided including the electron beam generator.

In accordance with a third aspect of the present invention, a molding method is provided that includes the steps of: molding a molded article in a molding system; providing an electron beam generator including an electron beam tube having an emitter for emitting an electron beam and a drive configured to controllably position the electron beam tube; and operating the electron beam generator to position the electron beam on a portion of a molded article for at least one of a sterilizing or crystallizing the portion of the molded article. More particularly, the process includes positioning the electron beam on a portion of a molded article to i) sterilize a portion of the molded article or ii) crystallize a portion of the molded article or iii) both.

A technical effect, amongst others, of the aspects of the present invention is a simple and inexpensive means to sterilize a portion of a molded article in the molding system. For the production of aseptic bottles from blow molded preforms the electron beam would may be used to internally, and perhaps externally, cleanse the preform prior to entering the aseptic blow/fill stage. The foregoing avoids complexities and limitations imposed by having to irradiate the large surface area and complex contours of a bottle and instead irradiates a smaller area and simpler shape of the preform and hence is less expensive and more reliable.

A technical effect, amongst others, of the aspects of the present invention is the ability to crystallize a portion of a molded article without excessive heating thereof (i.e. cold crystallization). The foregoing advantageously provides for one or more of: avoiding heating related shrinkage defects in the molded article; control formation of the crystalline structure to avoid excessive crystallinity (excessive crystallinity may cause unwanted haziness in the molded article); save on energy usage (e.g. large energy requirements of known method of heating high blow molds and venting large amounts of compressed air to atmosphere); amongst other things.

Another technical effect of the present invention is the flexibility and ease with which it may be integrated and/or retrofitted to molding systems.

### BRIEF DESCRIPTION OF THE DRAWINGS

A better understanding of the exemplary embodiments of the present invention (including alternatives and/or variations thereof) may be obtained with reference to the detailed description of the exemplary embodiments along with the following drawings, in which:

FIG. 1 is a simplified schematic representation of a just-molded preform undergoing sterilization by an electron beam generator according to a first exemplary embodiment (which is the preferred embodiment);

FIG. 2 is a plan view of an injection molding system including an electron beam generator according to a second exemplary embodiment for sterilizing just-molded preforms;

FIG. 3 is a simplified schematic representation of a blow molded bottle undergoing a controlled crystallization by an electron beam generator according to a third exemplary embodiment.

The drawings are not necessarily to scale and are may be illustrated by phantom lines, diagrammatic representations and fragmentary views. In certain instances, details that are not necessary for an understanding of the exemplary embodiments or that render other details difficult to perceive may have been omitted.

### DETAILED DESCRIPTION OF THE EXEMPLARY EMBODIMENTS

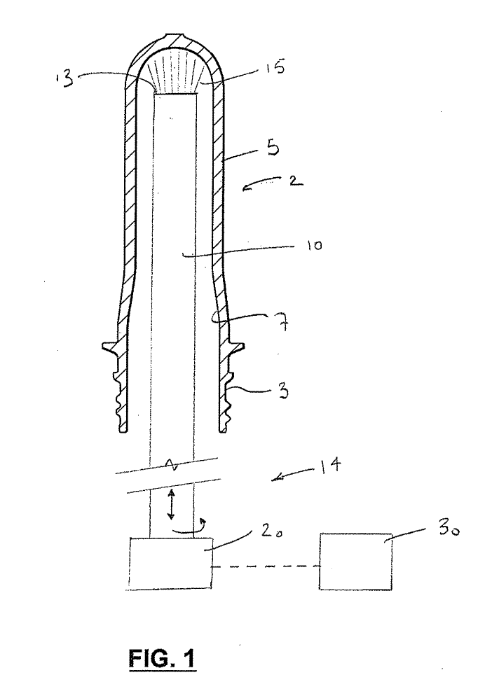

With reference to FIG. 1, an electron beam generator 14 in accordance with a first exemplary embodiment is shown that is configured for use in a molding system (not shown). The electron beam generator 14 may be operated to sterilize and/or crystallize a portion of a molded article 2, amongst other things. Accordingly, a molded article 2 such as an injection molded preform of the type that blow molded into a bottle may be cleansed, for example, prior to entering the aseptic blow/fill stage. The electron beam generator 14 may also be used in other applications where a sterile preform or preform-like object is required, including sterilizing a blood vial just prior to filling with a reagent or sealing.

For sake of producing aseptic packaging, such as beverage bottles, there are many different accepted levels of contamination (i.e. germs) that pass as “sterile”. Accordingly, “sterile” doesn't necessarily require absolutely zero germ count, but instead provides for a germ count reduction to an acceptable level depending on the needs of the application. Increasing the exposure time of a portion of the preform to the electron beam may effectively decrease the standard of sterilization (i.e. reduce germ count).

The electron beam generator 14 includes an electron beam tube 10 including an emitter 13 arranged at the end thereof for emitting an electron beam 15. An exemplary construction of the electron beam tube 10, may include a cathode (not shown) and a focusing structure (not shown), such as those described in U.S. Pat. No. 6,239,543. The electron beam generator 14 also preferably includes a drive 20 configured to controllably position the electron beam tube 10 to position the electron beam 15 on any desired portion of the molded article 2. The drive 20 is preferably configured to both rotate and reciprocate the electron beam tube 15, as shown with reference to the illustrative arrows. The drive 20 may incorporate commonly know mechanical and/or electro-mechanical means, such as, for example, an electric motor (e.g. linear and/or rotary).

In operation, one or both of the emitter 13 and the drive 20 are controlled to sterilize an interior portion 7 of the molded article 2, at least in part. Alternatively, the electron beam generator may be configured to sterilize an exterior portion of the molded article 2.

Alternatively, one or both of the emitter 13 and the drive 20 are operatively controlled to crystallize the interior portion 7 of the molded article, at least in part. For example, a neck portion 3 of the molded article may be crystallized.

Alternatively, one or both of the emitter 13 and the drive 20 are operatively controlled to crystallize the interior portion 7 in accordance with a crystallization profile. The crystallization profile may include, for example, a circumferential crystallization profile, a crystallization depth profile, or a longitudinal crystallization profile.

Alternatively, one or both of the emitter 13 and the drive 20 are operatively controlled to selectively crystallize the interior portion 7 in accordance with any pattern. For example, a hatched pattern of structurally reinforcing crystallized material may be imparted to a molded article 202 (i.e. bottle). Advantageously, the bottle having the hatched pattern of reinforcing crystallized material may acquire a distortion-resistance to being filled with a hot substance (i.e. hot-filled).

The electron beam generator 14 also preferably includes a controller 30 for controlling at least one of the emitter 13 and the drive 20. Any type of controller 30 may be used to control the emitter 13 and the drive 20, as described above. For example, one or more general-purpose computers, Application Specific Integrated Circuits (ASICs), Digital Signal Processors (DSPs), gate arrays, analog circuits, dedicated digital and/or analog processors, hard-wired circuits, etc., may send and/or receive control information, for example, from position encoders (not shown) of the drive 20, or to electronic driving structure for the cathode (not shown) or the electron beam focusing structure (not shown). Instructions for controlling the one or more of such controllers or processors may be stored in any desirable computer-readable medium and/or data structure, such floppy diskettes, hard drives, CD-ROMs, RAMs, EEPROMs, magnetic media, optical media, magneto-optical media, etc.

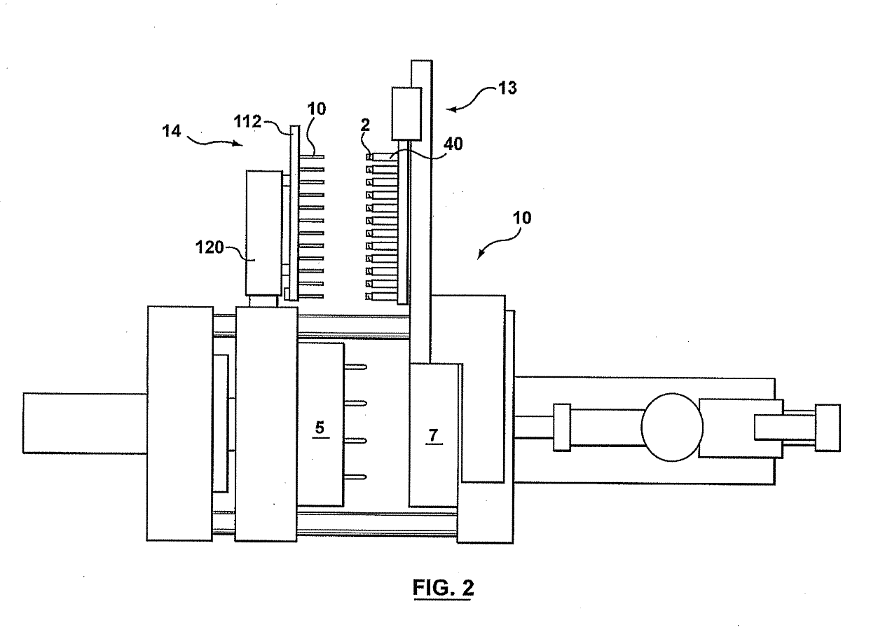

With reference to FIG. 2, an exemplary embodiment of a molding system 100 is shown. The molding system includes an injection molding structure 150, 152 for injection molding of molded articles 2 such as preforms of the type that are later blow molded into bottles. The molding system 100 includes a post-mold device 142 for retrieving just-molded articles 2 from the molding structure 150, 152. The post-mold device 142 includes an arrangement of molded article holders 140 that are configured to hold the preforms 2. The molding system 100 also includes an electron beam generator 114 according to a second exemplary embodiment for sterilizing an interior portion 7 (FIG. 1) of the preforms 2 and/or for crystallizing portions of the molded article as described in detail previously.

The electron beam generator 114 includes a drive 120 for positioning a plate 112 on which are arranged a plurality of the electron beam tubes 10 in an arrangement that corresponds with the arrangement of the molded article holders 140 on the post-mold device 142. In operation, the drive 120 is controllably operated to controllably position the electron beam tubes 10 within the interior portion 7 (FIG. 1) of the preforms 2 (while being held in the molded article holders 140.

In accordance with another exemplary embodiment of the molding system (not shown) the electron beam generator 14 in accordance with the first embodiment may be integrated in-line with a molded article singulator such as, for example, that described with reference to U.S. Pat. No. 6,942,480.

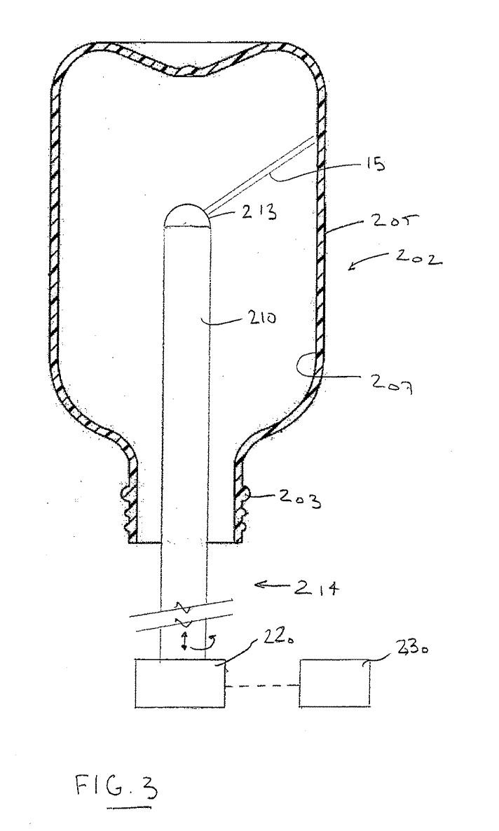

With reference to FIG. 3, an electron beam generator 214 in accordance with a third exemplary embodiment is shown that is configured for controllably crystallizing a molded article 202, such as a bottle, in a molding system (not shown). The molding system may include a blow molding cell (not shown). More particularly, the electron beam generator 214 may be arranged at a preform in-feed of a blow molding system (e.g. stretch blow molding or blow molding system.

The electron beam generator includes an electron beam tube 210 including an emitter 213 arranged at the end thereof for emitting an electron beam 15. The electron beam tube 210 preferably includes a focusing structure (not shown) such that the electron beam 15 may be oriented and/or focused on any desired portion across the interior 207 of the bottle 202. The electron beam generator 214 also preferably includes a drive 220 configured to controllably position the electron beam tube 10 to position the electron beam 15 adjacent any desired portion of the molded article 202. The drive 220 is preferably configured to both rotate and reciprocate the electron beam tube 215, as shown with reference to the illustrative arrows. The drive 220 may incorporate commonly know mechanical and/or electro-mechanical means, such as, for example, an electric motor (e.g. linear and/or rotary).

In operation, one or both of the emitter 213 and the drive 220 are operatively controlled to crystallize the interior portion 207 of the molded article, at least in part. For example, a neck portion 2033 of the molded article 202 may be crystallized.

Alternatively, one or both of the emitter 213 and the drive 220 are controlled to sterilize the interior portion 207 of the molded article 202, at least in part.

Alternatively, one or both of the emitter 213 and the drive 220 are operatively controlled to crystallize the interior portion 207 in accordance with a crystallization profile. The crystallization profile may include, for example, a circumferential crystallization profile, a crystallization depth profile, or a longitudinal crystallization profile.

Alternatively, one or both of the emitter 213 and the drive 220 are operatively controlled to selectively crystallize the interior portion 207 in accordance with any pattern. For example, a hatched pattern of structurally reinforcing crystallized material may be imparted to a molded article 202 (i.e. bottle). Advantageously, the bottle having the hatched pattern of reinforcing crystallized material may acquire a distortion-resistance to being filled with a hot substance (i.e. hot-filled).

The electron beam generator 214 also preferably includes a controller 230 for controlling at least one of the emitter 213 and the drive 220.

In accordance with yet another exemplary embodiment, the electron beam generator (not shown) may be configured to use the electron beam 15 to modify the internal or external wall of the molded article, such as a preform or bottle, so as to make the thermoplastic composition (e.g. PET) of the wall structure denser. Similarly the electron beam could be used in conjunction with a reactive gas or coating which together with the electron beam to again impart improved density by creating a new molecular structure. A technical effect of the foregoing may include a more cost-effective means of creating a gas barrier, scratch resistance or chemical resistance to a preform and/or bottle.

In accordance with yet another exemplary embodiment, the electron beam generator (not shown) may be configured with a filling system or a capping system.

In accordance with yet another exemplary embodiment, the electron beam generator (not shown) could be used to cross-link across an interface between layers of a multi-layer molded article, such as preforms and/or bottles, to reduce the delamination of the layers. The cross-linking would have the technical effect of increasing the chemical bonding of the PET and non-PET (barrier) layers.

The description of the exemplary embodiments provides examples of the present invention, and these examples do not limit the scope of the present invention. It is understood that the scope of the present invention is limited by the claims. The concepts described above may be adapted for specific conditions and/or functions, and may be further extended to a variety of other applications that are within the scope of the present invention. Having thus described the exemplary embodiments, it will be apparent that modifications and enhancements are possible without departing from the concepts as described. Therefore, what is to be protected by way of letters patent are limited only by the scope of the following claims:

What is claimed is:

1. An electron beam generator for use in a molding system, comprising:
an electron beam tube having an emitter for emitting an electron beam;
a drive configured to controllably position the electron beam tube to position the electron beam on a portion of a molded article.

2. The electron beam generator of claim 1, wherein:
at least one of the emitter and the drive configured to be controlled to sterilize an interior portion of the molded article, at least in part.

3. The electron beam generator of claim 1, wherein:
at least one of the emitter and the drive configured to be controlled to crystallize an interior portion of the molded article, at least in part.

4. The electron beam generator of claim 3, wherein:
at least one of the emitter and the drive configured to be controlled to crystallize the interior portion in accordance with a crystallization profile including at least one of: a circumferential crystallization profile; a crystallization depth profile; a longitudinal crystallization profile.

5. The electron beam generator of claim 3, wherein:
at least one of the emitter and the drive configured to be controlled to selectively crystallize the interior portion in accordance with any pattern.

6. The electron beam generator of claim 3, wherein:
at least one of the emitter and the drive configured to be controlled to crystallize a neck portion of the molded article.

7. The electron beam generator of claim 1, further including:
a controller for controlling at least one of the emitter and the drive.

8. A molding system, comprising:
a molding structure for producing molded article;
an electron beam generator including:
an electron beam tube having an emitter for emitting an electron beam;
a drive configured to controllably position the electron beam tube to position the electron beam on a portion of a molded article.

9. The molding system of claim 8, wherein:
at least one of the emitter and the drive configured to be controlled to sterilize an interior portion of the molded article, at least in part.

10. The molding system of claim 8, wherein:
at least one of the emitter and the drive configured to be controlled to crystallize an interior portion of the molded article, at least in part.

11. The molding system of claim 8, wherein:
at least one of the emitter and the drive configured to be controlled to crystallize the interior portion in accordance with a crystallization profile including at least one of: a circumferential crystallization profile; a crystallization depth profile; a longitudinal crystallization profile.

12. The molding system of claim 8, wherein:
at least one of the emitter and the drive configured to be controlled to selectively crystallize the interior portion in accordance with any pattern.

13. The molding system of claim 8, wherein:
at least one of the emitter and the drive configured to be controlled to crystallize a neck portion of the preform.

14. The molding system of claim 8, further including:
a controller for controlling at least one of the emitter and the drive.

15. The molding system of claim 8, wherein:
the molding structure includes injection molding structure.

16. The molding system of claim 8, wherein:
the molding structure includes blow molding structure.

17. The molding system of claim 8, wherein:
the molded article includes a preform or preform like article such as a test tube, vial or vacuum collection tube.

18. The molding system of claim 8, wherein:
the molded article includes a bottle.

19. A molding method, comprising:
molding a molded article in a molding system;
providing an electron beam generator including:
an electron beam tube having an emitter for emitting an electron beam; and
a drive configured to controllably position the electron beam tube;
operating the electron beam generator to position the electron beam on a portion of a molded article for at least one of a sterilizing or crystallizing the portion of the molded article.

20. The molding method of claim 19, further including:
controlling the emitter and the drive to sterilize an interior portion of the molded article, at least in part.

21. The molding method of claim 20, further including:
controlling the emitter and the drive to crystallize an interior portion of the molded article, at least in part.

22. The molding method of claim 20, further including:
controlling the emitter and the drive to crystallize the interior portion in accordance with a crystallization profile including at least one of: a circumferential crystallization profile;
a crystallization depth profile; a longitudinal crystallization profile.

23. The molding method of claim 20, further including:
controlling the emitter and the drive to selectively crystallize the interior portion in accordance with any pattern.

24. The molding method of claim 20, further including:
controlling the emitter and the drive to crystallize a neck portion of the molded article.

25. The molding method of claim 19, wherein:
the molding a molded article includes injection molding of the molded article.

26. The molding method of claim 19, wherein:
the molding a molded article includes blow molding or stretch blow molding of the molded article.
